(19) United States
(12) Patent Application Publication
(10) Pub. No.: US 2018/0215981 A1
(43) Pub. Date: Aug. 2, 2018

(54) SHAPE STABILIZED PHASE-CHANGE MATERIAL FOR HEAT RETENTIVE APPLICATIONS

(71) Applicant: EGC Enterprises, INC., Chardon, OH (US)

(72) Inventors: BRIAN BILLER, Mentor, OH (US); Richard L. DUDMAN, Lenoir, NC (US); Michael BARTOS, Chardon, OH (US)

(21) Appl. No.: 15/746,537

(22) PCT Filed: Jul. 29, 2016
(86) PCT No.: PCT/US2016/044613

§ 371 Date: Jan. 22, 2018

Related U.S. Application Data
(60) Provisional application No. 62/199,332, filed on Jul. 31, 2015.

(51) Int. Cl. C09K 5/06; F28D 20/02

(52) U.S. Cl. CPC C09K 5/063; F28D 20/023

(57) ABSTRACT

A thermal storage device includes a fabric base and a phase-change material provided on the base for storing and releasing heat applied to the thermal storage device.

### RELATED APPLICATIONS

This application claims priority from U.S. Provisional Application Ser. No. 62/199,332, filed Jul. 31, 2015, which is incorporated by reference herein in its entirety.

### TECHNICAL FIELD

The present invention relates generally to thermal storage devices and, more specifically, relates to a fabric infused with a phase-change material.

### BACKGROUND

Many sugar alcohols are commonly used as sweeteners in the food and beverage industries. It is also known that sugar alcohols can be used as solid-to-liquid phase change materials, as they often are readily available, inexpensive, have high latent heat of fusions (also known as enthalpy of fusion), and most having melting temperatures from 190° F. to 375° F. that are useful for heating and/or maintaining an elevated temperature in a variety of applications. Many sugar alcohols in their solid form have a crystalline structure, like sugar or salt (sorbitol, erythritol, xylitol, mannitol, lactitol, maltitol, etc.).

During cooling and crystallization, when re-solidifying from a liquid state, the sugar alcohols can form large, continuous pieces. Audible noises, such as popping sounds, are created from the sugar alcohol volume increasing as it changes state. The noise generated by the sugar alcohol as it heats and cools is not desirable in most thermal storage products.

Furthermore, as a liquid, the sugar alcohol requires containment, as any liquid would. As a solid, the sugar alcohol crystals are prone to cracking or breaking, and are rigid. It can be difficult to heat large piece or volumes of sugar alcohol quickly since they are thermal insulators having thermal conductivities under 1 W/mK.

### SUMMARY

In one example, a thermal storage device includes a fabric base and a phase-change material provided on the base for storing and releasing heat applied to the thermal storage device.

In another example, a method of heating a substrate includes providing a thermal storage device having a fabric base and a phase-change material provided on the fabric base. The substrate is positioned adjacent the thermal storage device. The phase-change material is cyclically heated and cooled to heat the substrate

In another example, a method of forming a thermal storage composite material includes providing a fabric base and infusing a phase-change material into the fabric base.

Other objects and advantages and a fuller understanding of the invention will be had from the following detailed description and the accompanying drawings.

### BRIEF DESCRIPTION OF THE DRAWINGS

FIG. 1 is a top view of a single layer thermal storage device in accordance with the present invention.

FIG. 2 is an exploded view of a multilayer thermal storage device.

FIG. 3 is an exploded view of the thermal storage device of FIG. 2 further including a resistive heating element.

FIG. 4 is an exploded view of the thermal storage device of FIG. 2 further including a wire resistive heating element.

FIG. 5 is an exploded view of the thermal storage device of FIG. 2 further including a thermal spreading material.

FIG. 6 is an exploded view of the thermal storage device of FIG. 3 further including a thermal spreading material.

FIG. 7 is an exploded view of the thermal storage device of FIG. 2 further including a thermal spreading material.

FIG. 8 is a cross-section of the thermal storage device of FIG. 2 enclosed in a housing.

FIG. 9 is an exploded view of the thermal storage device of FIG. 6 with a housing for encapsulating the thermal storage device.

FIG. 10A is an exploded view of the thermal storage device of FIG. 7 with a housing for enclosing the thermal storage device.

FIG. 10B is a cross-section of the thermal storage device of FIG. 10A when encapsulated within the housing.

FIG. 11 is a schematic illustration of a food delivery device in accordance with the present invention.

### DETAILED DESCRIPTION

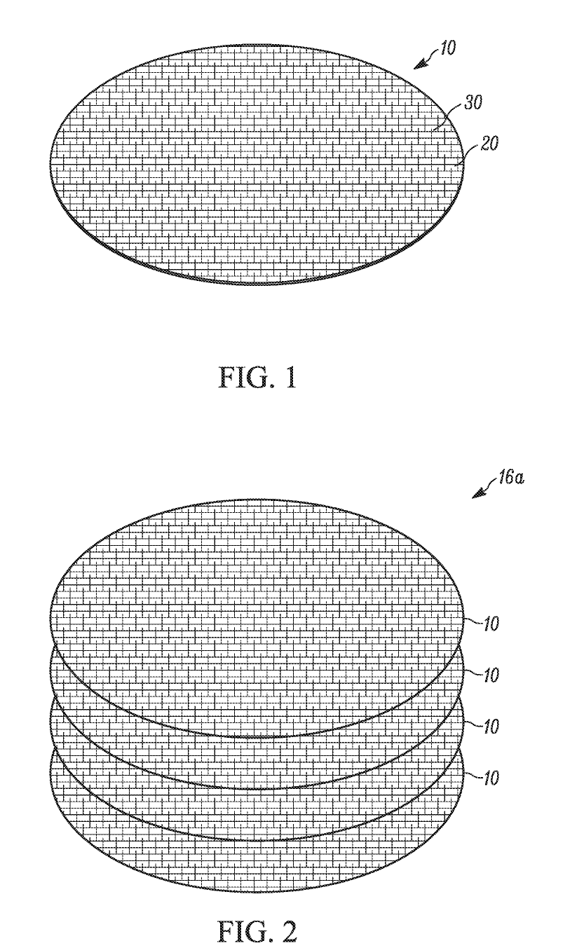

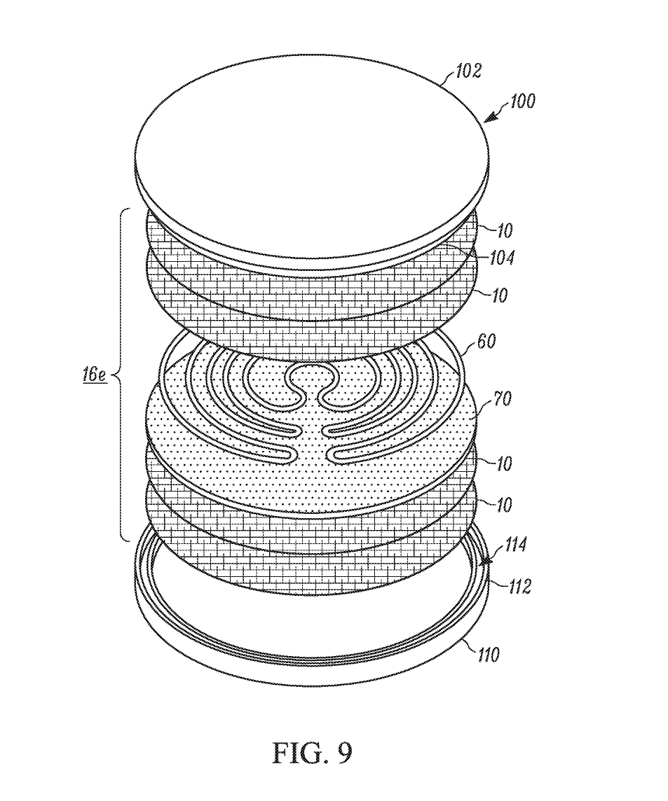

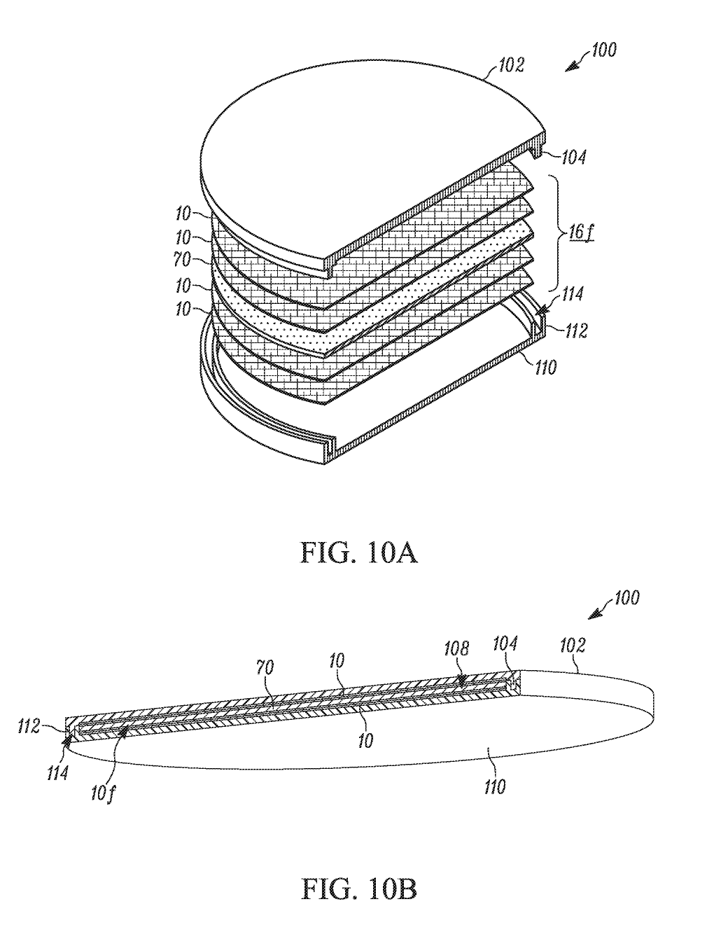

The present invention relates generally to thermal storage devices and, more specifically, relates to a fabric infused with a phase-change material. FIGS. 1-10B illustrate thermal storage composite materials and devices in accordance with the present invention. Referring to FIG. 1, the thermal storage device 16a constitutes a composite material 10 that includes a fabric base 20 and a phase-change material 30 provided on the base. The fabric 20 can be any man-made or natural fabric which is adsorbent and capable of withstanding high-temperature. Examples fabrics 20 can include, but are not limited to, fiberglass, carbon fiber, silica, cotton, polyester, wool, linen, acrylic, aramid, basalt, and nylon.

The fabric 20 can have a loose or tight weave woven in any pattern depending on the application. In one example, the fabric 20 can utilize chopped strand mat materials (CSM) having fibers laid randomly across each other and held together by a binder, e.g., a polyester-based or styrene-based binder. CSM can include fiberglass chopped strand mat, fiberglass continuous strand mat, fiberglass continuous strand veil, carbon fiber mat, carbon fiber continuous strand veil, aramid veil, and aramid mat.

The phase-change material 30 can be any substance with a high heat of fusion at a certain temperature, is capable of storing and releasing large amounts of energy when melted and solidified. In one example, the phase-change material 30 constitutes a sugar alcohol that includes at least one of methanol, arabinitol/arabitol, erythritol, fucitol/L-fucitol, galactitol, dulcitol, iditol/D-iditol, inositol, isomalt, lactitol, lactitol (monohydrate), maltitol, maltotetritol, mannitol, palatinitol, pentaerythritol, polyglycitol, ribitol, sorbitol, threitol, volemitol, and xylitol.

The phase-change material 30 reacts to temperature fluctuations in order to store and release energy as the material cyclically heats and cools. That said, the specific phase-change material(s) 30 chosen for the composite material 10 is selected based on its melting point, specific heat, thermal stability, latent heat of fusion, decomposition temperature, and/or cost. The phase-change material 30 cooperates with the fabric 20 base to form a shape-stabilized composite material 10 having beneficial thermal properties.

The fabric 20 acts to contain, and provide structural stability for, the phase-change material 30. In the case of sugar alcohol, this structural stability helps prevent the formation of large crystals in the sugar alcohol during heating and cooling, which not only greatly enhances the flexibility in the composite material 10 but helps to eliminate the aforementioned audible noise during crystallization/cooling of the sugar alcohol.

A combination of phase-change materials 30 can be used to change the cooling profile of the composite material 10. For example, a first sugar alcohol infused into the fibers can be chosen to quickly drive up and hold the composite material 10 temperature by rapidly adsorbing any heat applied thereto. After the energy has been dissipated within the composite material 10 and the first sugar alcohol allowed to solidify, a second sugar alcohol infused into the fibers could remain melted to hold the composite material at a lower, more desirable temperature.

The particular phase-change materials 30 chosen should be thermally stable, i.e., there should be no change in the melting temperature and latent heat storage as the composite material 10 is repeatedly cycled through heating and cooling phases. For example, it is known that sugar alcohols dulcitol and D-mannitol have low thermal stability and therefore their melting points, enthalpy, and/or heat storage capacity can change as they are melted and cooled/solidified.

The sugar alcohol 30 can be provided on the fabric 20 in several ways. In one example, the sugar alcohol 30 is melted in a bath and the fabric 20 passed therethrough, allowing the fabric to adsorb the molten sugar alcohol. The fabric 20 is then removed from the molten sugar 30 bath and cooled to form the composite material 10. As the composite material 10 cools, the liquid sugar alcohol 30 within the fabric 20 solidifies and retains the shape of the fabric fibers. Surface tension in the sugar alcohol may allow it to solidify within some or all of the gaps between fibers in the fabric 20. Regardless, the cooled composite material 10 can then be rolled up or sheeted.

In another example, a solvent is used to dissolve sugar alcohol 30 into the fabric 20. In this configuration, the fabric 20 is initially passed through a solvent/sugar alcohol 30 solution. The liquid solvent on the fibers is then heated to the point of evaporation, thereby leaving only the sugar alcohol 30 behind on the fabric 20 to form the composite material 10, which is then cooled and processed as described above.

In either case, it is desirable for the phase-change material 30 to be uniformly distributed throughout the fabric 20. To this end, the adsorption of the sugar alcohol 30 onto the fabric 20 can be enhanced by burning off any binders, lubricants, anti-static agents, and/or other coatings commonly used during manufacture of the fabric 20. This is particularly advantageous when fiberglass is used as the fabric 20.

When a fiberglass fabric 20 is infused with sugar alcohol 30 surface tension is utilized to retain the sugar alcohol within the fabric structure. The expansion and contraction of the sugar alcohol 30 during heating and cooling is therefore confined to the volume of the fabric 20. As a result, the volume of the composite material 10 does not change as it cycles up and down in temperature.

The fabric 20 chosen should have a melting temperature, decomposition temperature, and/or auto-ignition temperature above the melting point of the selected phase-change material 30. The fabric 20 should also be capable of adsorbing over 0.25 ounces of phase-change material 30 per cubic inch of fabric. The volume of the composite material 10 could be, in one example, over 50% phase-change material 30 of the total composite volume. The volume of each component 20, 30 is calculated using measured weights along with the published densities of the components.

The composite material 10 can be formed in one layer or multiple layers secured together in an overlying manner to form a thicker composite material. In one example, the composite material 10 can have a thickness on the order of about 0.005″ to about 0.25″, but could be thicker depending on the fabric material(s) used. That said, one layer or multiple layers of the composite material 10 can act as the thermal storage device.

FIG. 2 illustrates another example thermal storage device 16a having a plurality of composite material 10 layers. Although four composite material 10 layers are illustrated, it will be appreciated that more or fewer layers can be utilized. The composite material 10 layers can have the same thickness or different thicknesses. Furthermore, the same phase-change material 30 can be provided on each composite material 10 layer or different phase-change materials can be used on different layers.

The composite material 10 layers can be fused together by melting the phase-change material 30 in each layer. This is accomplished by heating the composite material 10 layers above the melting temperature of the phase-change material 30 while applying a compressive force to the composite material 10 stack. The cooled phase-change material 30 acts to bind the composite material 10 layers together without the need for additional adhesives.

Alternatively or additionally, the composite material 10 layers can be held together mechanically or adhered together with a separate adhesive. To laminate the composite material 10 layers together, tape can be applied to both sides of the composite material stack while leaving the perimeter of the tape exposed to enable the tape edges to be sealed together. A pressure-sensitive or heat-sensitive adhesive on the tape would be activated by hand or heated press, respectively, to laminate the tape layers together around the composite material 10 stack.

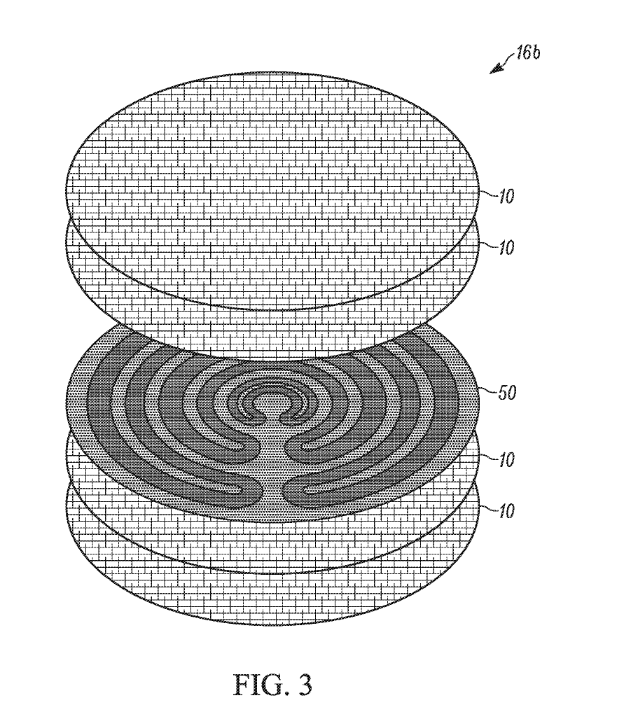

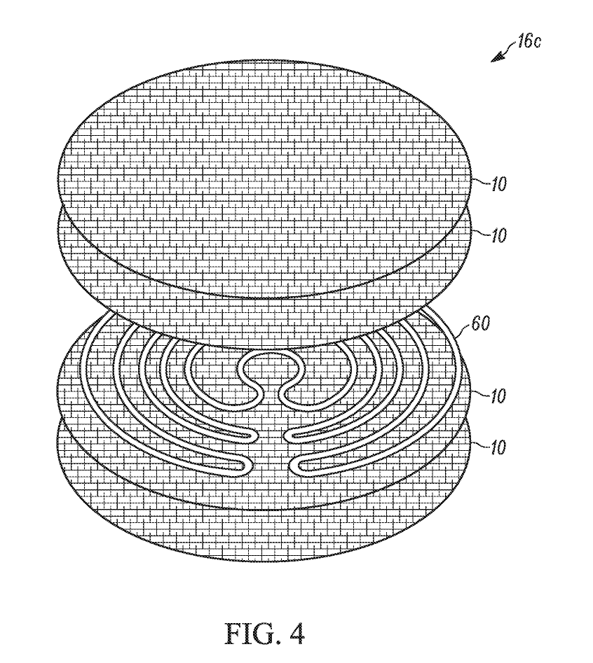

FIGS. 3-7 illustrate additional example thermal storage devices 16b-16f in accordance with the present invention. The composite material 10 layers in the thermal storage devices 16b-16f can be secured together in any of the manners previously described. Referring to FIGS. 3-4, the thermal storage device 16b includes a plurality of composite material 10 layers and a resistive heating element 50 or 60 positioned between the composite material layers to enable charging of a heat retentive product. Although one resistive heating element 50 is illustrated, it will be appreciated that multiple resistive heating elements 50 can be provided between multiple pairs of composite material 10 layers.

As shown in FIG. 3, the resistive heating element 50 constitutes a flexible graphite, thin film heater. In this configuration, the resistive heating element 50 can constitute an etched metal-type thin film heater which can be insulated with silicone, polyimide, or another polymer film. In yet another example, the resistive heating element 50 constitutes a screen-printed or conductive ink heater which can be self-regulating and have a positive temperature coefficient of resistance. In any case, the resistive heating element 50 can have a large surface area comparable to the footprint of the fabric 20 to enable fast, even heating of the sugar alcohol 30 throughout the fabric.

In the example shown in FIG. 4, a thermal storage device 16c includes a resistive heating element 60 having a smaller configuration in the form of a wire, cartridge or calrod-style heater.

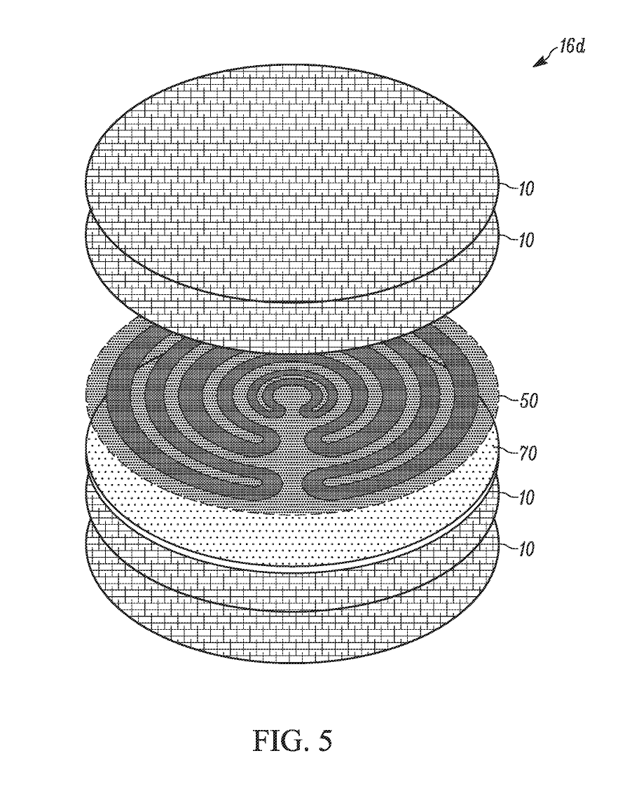

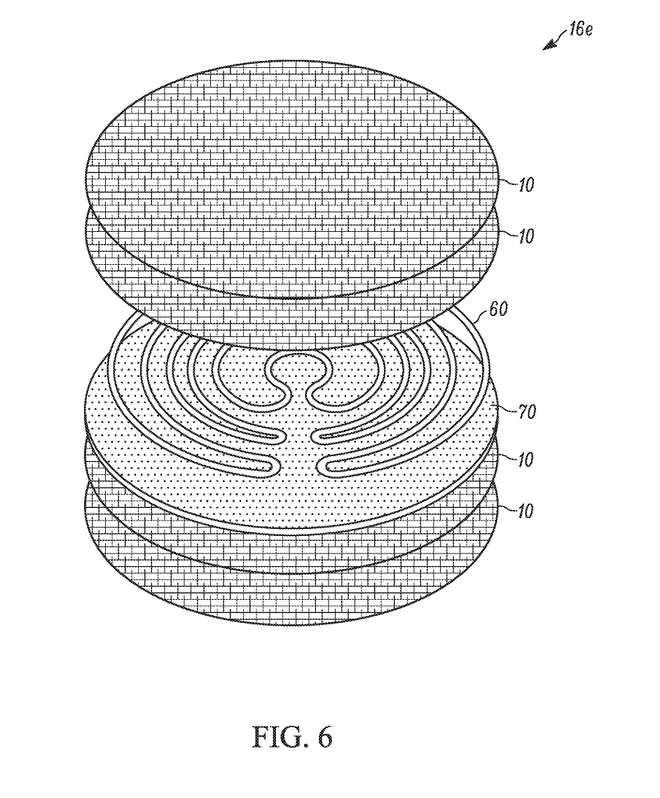

Referring to FIGS. 5-6, the thermal storage devices 16d, 16e include both the resistive heating elements 50, 60, respectively, as well as a thermal heat spreading material 70 to help improve the evenness of heating the composite material 10 layers. The heat spreading material 70 can also help prevent thermal degradation of the sugar alcohol 30 and/or the fabric 20 base. The heat spreading material 70 can constitute flexible graphite or metal foils/sheets with high thermal conductivity, such as aluminum.

As shown, the thermal heat spreading material 70 is positioned between, e.g., beneath as shown or above (not shown), the resistive heating element 50, 60 and the adjacent composite material 10 layer. Consequently, the thermal heat spreading material 70 abuts both the resistive heating element 50, 60 and the adjacent composite material 10 layer. If more than one resistive heating element 50, 60 is provided in the thermal storage device 16d, 16e a heat spreading material 70 can be provided with some or all of the resistive heating elements above or below the respective resistive heating element.

In each case, the resistive heating element 50, 60 are provided to heat the sugar alcohol 30 in the composite material 10 layers. The geometry of the resistive heating element 50, 60 can produce hot spots in the fabric 20 in direct contact with the resistive heating element compared to portions of the fabric spaced therefrom. The heat spreading material 70 acts as a buffer between the resistive heating element 50, 60 and the fabric 20 and evenly distributes the heat produced by the resistive heating element to a larger percentage of the fabric area. This helps to reduce the aforementioned fabric 20 hot spots.

This configuration is advantageous in that the more even heating helps protect heat-sensitive components of the thermal storage device 16d, 16e, such as plastic housings and circuitry, from damage/overheating. Moreover, the more even heating can help utilize the full energy capacity of the composite material 10, because even heating allows for a higher energy input to the composite material. If all portions of the composite material 10 are at similar temperatures, all the phase-change material 30 therein can be melted and a higher % of the overall phase-change material volume can be driven to higher temperatures, exceeding the melting temperature, provided no locations within the composite material exceed the point where thermal degradation begins.

Additionally, the heat spreading material 70 helps account for application dependant thermal load variations during operation and acts quickly to distribute the thermal load, thereby keeping temperature more even.

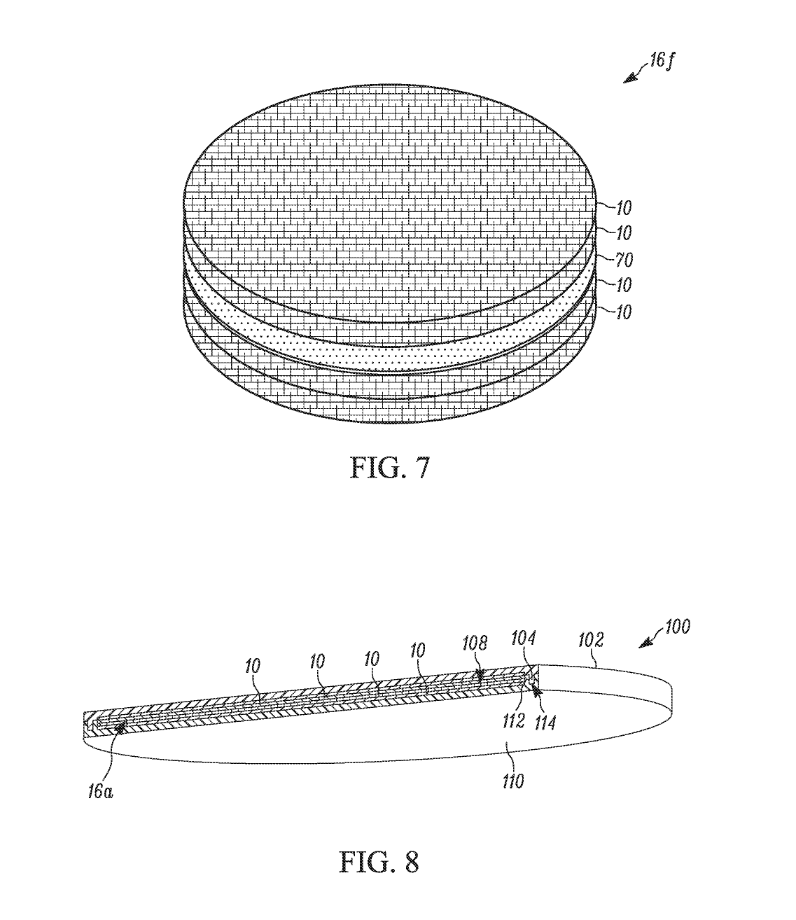

FIG. 7 illustrates a thermal storage device 16f that includes the thermal heat spreading material 70 but omits the resistive heating elements 50, 60.

With any of the aforementioned constructions of the thermal storage devices 16a-16f, it can be desirable to encapsulate or contain the sugar alcohol 30 within the fabric 20 to prevent any loss of the sugar alcohol during melting/cooling and to help prevent delamination of the composite material or thermal storage device. This is particularly desirable when mechanical abuse and moisture retention in the composite material/thermal storage device are a concern. To this end, since sugar alcohol 30 is water soluble it can be desirable to isolate the thermal storage device 16a-16f from sources of moisture to prevent any possible reduction of thermal storage capacity in the composite material 10 layers. This can be accomplished by laminating, coating or otherwise providing non-porous materials around the thermal storage device 16a-16f. The non-porous material can also be vacuum bagged (vacuum sealed in a poly-bag) to provide containment against moisture.

FIGS. 8-10B illustrate examples of housings 100 that help protect the thermal storage devices 16a-16f. Although the thermal storages devices 16a, 16e, and 16f are shown, it will be appreciated that the housing 100 could likewise be used with any of the thermal storage devices 16a-16f described herein.

The housing 100 includes a first component 102 and a second component 110. The components 102, 110 cooperate to define a chamber 108 for receiving the thermal storage device. The first component 102 has generally the same shape and footprint as the thermal storage device, e.g., circular or polygonal. A projection 104 extends around the periphery of the first component 102. In one example, the projection 104 is rectangular but could have another shape. The second component has the same shape as the first component 102 and includes a projection 112 extending around its periphery. The projection 112 defines a recess 114 shaped to receive the projection 104 on the first component 100. In one example, the projection 104 and recess 114 are configured to form a snap-fit connection with one another that seals the thermal storage device within the chamber 108 of the housing 100.

The components 102, 104 can be formed from molded materials, e.g., plastic or polymer, and can be secured together around the thermal storage device 16a-16f via fasteners, weld or adhesive to cover/encapsulate the thermal storage device. This may be in addition to or in lieu of the snap-fit connection between the components 104, 114.

Alternatively, the thermal storage devices 16a-16f can be insert molded into plastic products or secured between pairs of plastic components via glue, weld or the like. In these configurations, the thermal storage devices 16a-16f can be protected by formed/cast metals, rubber, epoxy, and other materials. Additionally, the thermal storage devices 16a-16f could be held mechanically between pair(s) of rigid, non-porous structures.

Other manners for encapsulating the thermal storage devices 16a-16f include, but are not limited to, injection molding or over molding, encapsulating by a heat activated shrink film or wrap, encapsulating by an expanding foam or encapsulating by a cured coating applied by, for example, spraying, brushing, dipping, etc. The coating can include polymer coatings, rubber coatings, such as vulcanized rubber, phenolic coatings, and epoxy coatings. The coating can be cured by, for example, ultraviolet light, heat or chemical(s).

In operation, the thermal storage device 16a-16f can be heated by any one or more of conduction, convection or radiation and, thus, can be heated by ovens, heat-lamps, hot air blowers, hot plates or other heating devices. The thermal storage devices 16a-16f can also be bonded to an induction-heatable material to enable induction heating of the sugar alcohol 30. The induction-heatable material can constitute flexible graphite or another metal.

The thermal storage devices 16a-16f can be configured to be used in a variety of thermal storage or heat retention devices. In one instance, the components forming the composite material 10 layers can be chosen to be non-toxic and safe for use in food service or medical industries. Common applications include food delivery, therapeutic devices, personal garment warming, medical applications (sterilization), and defrosting uses.

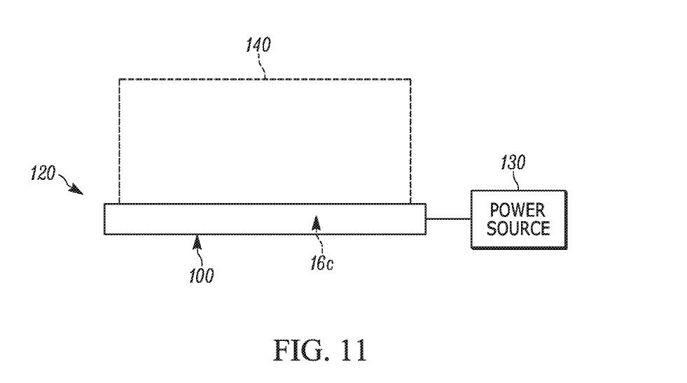

Referring to FIG. 11, one example application is for a food delivery device 120 in which the thermal storage device 16c is used a disk made for pizza delivery. The disk 120 consists of multiple layers of the shape stabilized component material 10, a thin film heater 50, and a plastic shell 100 molded over the disk (see FIG. 3). This unit 120 can be charged to melt the phase-change material 30 within the composite material 10 layers by applying power from a source 130 to the resistive heating element 50. Once charged, the unit 120 may be placed inside an insulating bag or box along with a pizza 140 to maintain the pizza at a desired temperature.

Another application is a food holding cart with panels of the composite material 10 heated within the insulated cart by a resistive element 50. Once fully heated above the melting point of the sugar alcohol 30, the cart will keep food hot for hours, thereby allowing catering services to expand their geographic footprint, as the carts are normally unpowered during transport.

A third application is an improved version of U.S. Pat. No. 6,657,170. In this instance, the heat retentive material, which is normally a solid-to-solid phase change material, is replaced with the composite material 10 of the present invention. When comparing heat retentive materials, an induction-heatable device made with Erythritol/1522 E glass shape stabilized pcm can store about 20% more energy than PEX (cross-linked polyethylene) solid-to-solid phase change material of the same volume (assuming both are heated to 119° C. from room temperature). This allows the laminate stack of composite materials 10 to remain the same thickness while providing more energy storage capacity. Alternatively, the laminate stack of composite materials 10 may be made thinner or smaller and still store the same amount of energy.

As another alternative, composite materials 10 having a thickness less than 0.5″ can be formed into curves to be applied to pipes, cylindrical vessels or any other non-planar surface where thermal management is desirable.

### Example

A composite material was formed using style 1522, E-Glass fiberglass woven fabric infused with Erythritol. This particular fiberglass was chosen due to its excellent tensile strength, it is not flammable, it is inexpensive, and has a relatively high thermal conductivity of 1.2-1.35 W/mK. The fiberglass also is thin enough to allow for rapid and consistent adsorption of sugar alcohol. Its surface area-to-volume-ratio allows the composite to cool quickly, which permits the material to be rolled or sheeted at a faster rate than other, thicker fabrics. Fiberglass is also much more flexible than other, thicker fabrics and easier to cut.

Furthermore, any binders, lubricants or chemical finishing agents commonly used during the manufacture of fiberglass were quickly burned off to help aid in the sugar alcohol adsorption. Fiberglass also retains a high volume, e.g., over 60% of the overall composite volume, of Erthritol.

Erythritol was chosen due to its thermal stability. Erythritol consistently and continually absorbs and releases energy without significant degradation in performance. It has a melting temperature of approximately 250° F., which is useful for holding food items above the temperature where bacterial growth is a concern. It has a high heat of fusion of 340 KJ/Kg and a density of 1.45 g/cm3. This combination allows for a relatively large amount of thermal energy to be stored in a given volume.

The composite material absorbs energy in a manner that limits the temperature of an object placed thereon to be heated. In this case a layer or layers of composite material could be placed adjacent to an object, for example, a heater. The composite material layers will heat relatively easily until reaching the point where the erythritol changes state. In one instance, the erythritol is melted at 250°, with roughly 40% of the energy being required to heat from 70° F. to 250° and the remaining 60% or so being required to change state at 25° F. With this in mind, if the desired working temperature of the heating device were to be from 100-250° F., the composite material layers could be used to temporarily stop the increase in temperature at 250°, should the heater be left on for too long.

Many sensors don't react quickly to temperature fluctuations due to thermal transfer efficiency issues and their thermal mass. This becomes even more problematic in a faster reacting systems since a delay in shut-off can mean a substantial overshoot in temperature. By placing the composite material layers into the assembly, the temperature would climb quickly to 250° F. and stop for a period of time, proportional to the mass or volume of the composite material layers. This should allow enough time for the sensor controlling the circuit to react, prior to the temperature climbing any higher. This advantageous protection can help prevent localized degradation on a larger surface, as sensors can only sense at a single point.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A thermal storage device comprising a fabric base and a phase-change material provided on the base for storing and releasing heat applied to the thermal storage device.

2. The thermal storage device recited in claim 1, wherein the fabric comprises at least one of fiberglass, carbon fiber, silica, cotton, polyester, wool, linen, acrylic, aramid, basalt, and nylon.

3. The thermal storage device recited in claim 1, wherein the phase-change material is a sugar alcohol comprising at least one of methanol, arabinitol, erythritol, fucitol, galactitol, dulcitol, iditol, inositol, isomalt, lactitol, lactitol (monohydrate), maltitol, maltotetritol, mannitol, palatinitol, pentaerythritol, polyglycitol, ribitol, sorbitol, threitol, volemitol, and xylitol.

4. The thermal storage device recited in claim 1, wherein the phase-change material is infused into fibers of the fabric.

5. The thermal storage device recited in claim 1 further comprising a second fabric base and a phase-change material provided on the second fabric base.

6. The thermal storage device recited in claim 5, wherein the phase-change materials are melted together to secure the fabric base to the second fabric base.

7. The thermal storage device recited in claim 5 further comprising a resistive heating element provided between the fabric base and the second fabric base for heating the phase-change materials.

8. The thermal storage device recited in claim 7 further comprising a thermal heat spreading material provided between the fabric base and the resistive heating element for providing uniform heating to the phase-change materials.

9. The thermal storage device recited in claim 8, wherein the thermal heat spreading material is flexible graphite.

10. The thermal storage device recited in claim 5 further comprising a heat spreadable material provided between the fabric base and the second fabric base for providing uniform heating to the phase-change materials

11. The thermal storage device recited in claim 5 further comprising an induction-heatable material for heating the phase-change materials.

12. A method of heating a substrate comprising:
providing a thermal storage device comprising a fabric base and a phase-change material provided on the fabric base;
positioning the substrate adjacent the thermal storage device; and
cyclically heating and cooling the phase-change material to heat the substrate.

13. The method of claim 12, wherein the phase-change material is heated by at least one of conduction, convection, and radiation.

14. The method of claim 12, wherein the phase-change material is sugar alcohol.

15. A method of forming a thermal storage composite material comprising:
providing a fabric base; and
infusing a phase-change material into the fabric base.

16. The method of claim 14, further comprising burning off at least one of binders, lubricants, anti-static agents, and coatings from the fabric base prior to infusing the fabric base with the phase-change material.

17. The method of claim 14, wherein the step of infusing the phase-change material into the fabric base comprises melting the phase-change material, passing the fabric base through the melted phase-change material, and cooling the phase-change material on the fabric base.

18. The method of claim 14, wherein the step of infusing the phase-change material into the fabric base comprises providing a solvent to dissolve the phase-change material and form a solution, passing the fabric base through the solution, and heating the fabric base to evaporate the solvent.

19. The method of claim 14, wherein the phase-change material is sugar alcohol.
